(19) United States
(12) Patent Application Publication
(10) Pub. No.: US 2026/0228843 A1
(43) Pub. Date: Aug. 6, 2026

(54) SYSTEMS AND METHODS FOR USING ARTIFICIAL INTELLIGENCE TO OPTIMIZE SKILL DEVELOPMENT AND CAREER PLANNING IN EDUCATION

(71) Applicant: Ellucian Company LP, Malvern, PA (US)

(72) Inventor: Evan Claudeanos, Malvern, PA (US)

(21) Appl. No.: 19/460,582

(22) Filed: Jan. 27, 2026

Related U.S. Application Data
(60) Provisional application No. 63/752,926, filed on Feb. 3, 2025.

(51) Int. Cl. G06Q 50/20

(52) U.S. Cl. CPC G06Q 50/205

(57) ABSTRACT

A system leveraging artificial intelligence (AI) optimizes skill development and career planning for students and educational institutions. It dynamically generates a skills ontology by analyzing the institution's course catalog and curriculum data, creating a framework that maps academic offerings to workforce needs. The system provides personalized career pathway recommendations to students, aligning their academic progress and interests with industry demands. Additionally, it identifies skill gaps by comparing the skills ontology with real-time job market data, enabling institutions to update curricula proactively. This AI-driven approach ensures alignment between educational programs and evolving workforce requirements, enhancing institutional planning and student career outcomes. Designed for seamless integration with existing data systems, the system provides a scalable and adaptive solution for maintaining workforce readiness and improving the relevance of academic programs.

### RELATED APPLICATION

This application claims benefit under 35 U.S.C. § 119 (e) to U.S. Provisional Application Ser. No. 63/752,926, entitled “Systems And Methods For Using Artificial Intelligence To Optimize Skill Development And Career Planning In Education” filed Feb. 3, 2025.

### TECHNICAL FIELD

The present invention relates to curriculum development and analysis, learning and career pathway analysis, and student career and workforce readiness in the field of education, particularly a set of automated threshold, natural language processing, neural network, and artificial intelligence methods for achieving alignment among college curriculum, student career goals, labor market demand, and specific workforce outcomes for students pertaining to those students' job prospects, significantly improving on the conventional human-constructed approaches.

### BACKGROUND OF THE INVENTION

The advent of artificial intelligence (AI) has transformed numerous industries, including education. Traditional educational systems often follow a one-size-fits-all model, where curricula and learning paths are standardized and offer limited personalization. While this approach provides a foundational structure, it often fails to address the unique needs, aspirations, and capabilities of individual learners. Similarly, educational institutions struggle to align their offerings with dynamic labor market demands, leading to skill mismatches and underprepared graduates.

Currently, institutions maintain the underlying data that informs their course catalog and curriculum through a series of administrative forms within their Student Information System (SIS) and Learning Management System (LMS). These forms capture various data such as department, subject, course titles, course descriptions, instructional method, credit hours, etc. that then are published in the student-facing course catalog. However, these resources are not typically leveraged to their fullest potential to create a cohesive skills ontology that maps course offerings to specific, in-demand skills and in turn to specific job or occupational outcomes for students.

A skills ontology—a structured framework that defines relationships among skills, courses, and career pathways—can serve as a vital tool for enhancing personalization and labor market alignment. Simply put, what is not captured is the overall mapping of this curriculum to skills—the learning behind the course. Without this knowledge, institutions run the risk of being disconnected from the workforce, and not being able to manage and track—with data—how well their current curriculum is preparing students for jobs.

There also appears to be a “credit-first” bias in the management of learning. This has served higher education well in the past, as historically institutions could depend on students being able to afford long durations of study in “traditional” credit-based degrees. With the surge of non-credit options that have done a better job of connecting students to the workforce like bootcamps or certifications, and Massive Open Online Courses (MOOCs), institutions are now under threat of being cut out from the next generation of students. Institutions currently do not have a way of “unbundling” their current learning into more stackable options for learning. They also lack the technology to calculate the relevance of their course offerings to specific workforce outcomes for students and the platform to demonstrate that relevance to prospective students to boost engagement and enrollment.

Students and job seekers also face challenges in identifying viable career pathways that align with their existing competencies and aspirations. AI can play a pivotal role in analyzing institutional data, identifying relevant skills, and recommending optimal career trajectories based on both individual profiles and labor market trends. Such functionality not only empowers learners but also provides institutions with actionable insights to improve program design and delivery.

A further complication arises from the gap between the skills taught in academic institutions and those required by employers. This misalignment creates a pressing need for institutions to better understand current job market demands and adapt their offerings accordingly. By using AI to identify skill gaps, educational institutions can ensure their graduates are equipped with the competencies necessary for career success, thus enhancing their employability and overall institutional effectiveness.

This invention addresses these challenges and more by leveraging AI to: (1) generate a skills ontology from institutional catalog and curriculum data, (2) deliver personalized career pathway and course recommendations to students, and (3) identify skill gaps for institutions based on labor market needs. The proposed system creates a bridge between educational offerings and employment requirements, enabling institutions to better serve both students and the job market while promoting lifelong learning and workforce readiness.

### BRIEF SUMMARY OF THE INVENTION

To address these issues, applicant has developed “Journey” which is a lifelong learning platform and NLP modeling pipeline that assigns skill-mastery scores to multiple industries/skills based on text from relevant documents and descriptions (e.g., SIS, course catalog(s), syllabi, job postings, employment evaluations, etc.). Journey involves several distinct components that are necessary for successful and robust industry/skill classification(s) and educational-path mapping. The first is a text pre-processing approach utilizing an ensemble machine learning architecture. The second is a human-in-the-loop workflow that leverages multiple topic models to convert keywords into industry/skill mastery values. The third is a post-processing algorithm that adjusts and corrects the model-estimated values based on correlations and hierarchical relationships between industries/skills. The fourth is a neural network embeddings-based approach to identify which skills are being taught in a given course. The fifth is an algorithmic approach to ascertaining the degree to which each skill is taught in a given course, or how well that course covers the skill in question. Unlike black-box LLM models, this approach relies on a unique mathematical structure, which allows for a particularly high level of human-interpretability and understanding, ensuring that robust industry/skill mastery and career alignment properties is possible in practice. This empowers students, employees, employers, administrators, and their employees or agents to both map and assess how well an individual has mastered in-demand skills for relevant industries, such that they are able to rapidly iterate and improve the model to correct for any identified mistakes and map out/evaluate the most appropriate/personalized educational path for each user. In certain embodiments, the described invention may be used by hiring managers or administrators to evaluate how educational courses align with specific desired skill mastery.

The first step in using the system and method disclosed herein involves gathering relevant data from various sources such as the SIS, course catalogs, job postings, and local, state, and federal employment databases. This data serves as the foundation for the subsequent analysis. The data harvesting may occur at set intervals or continuously. Furthermore, the harvesting may be based on a set of guardrails previously uploaded to a database by an administrator/hiring manager, user or an employee, contractor, or agent of the user or administrator/hiring manager. For example, the hiring manager may direct the system to harvest data from only specifically identified companies (e.g., the hiring manager may restrict the data collection to only industry competitors).

Once the data is collected, it undergoes preprocessing to ensure consistency and compatibility. This may involve standardizing data formats, cleaning missing values, and aligning data with the attributes used in the models. Preprocessing ensures that the data is ready for analysis and modeling. Again, how the system engages in pre-processing of the data will have been previously uploaded to a database by an administrator/hiring manager, user or an employee, contractor, or agent of the user or administrator/hiring manager.

With the preprocessed data in hand, the next step is to generate text embeddings and estimate the parameters of the models. These parameters include industry/skill mastery distributions and the skill-specific distributions over these industry-mastery distributions. This may occur via Bayesian inference techniques. Bayesian inference incorporates prior knowledge and uncertainty into the parameter estimation process, leading to more robust estimates.

After estimating the parameters of the models, industry skills or skills of interest are identified based on previous inputs from an administrator/hiring manager, user or an employee, contractor, or agent of the user or administrator/hiring manager. Industries may also be identified by market trends, user preferences, or economic forecasts. For example, industries could include emerging technologies, sustainable energy, healthcare innovation, among others.

For each industry, criteria or characteristics previously uploaded by an administrator/hiring manager, user or an employee, contractor, or agent of the user or administrator/hiring manager are used to label or identify relevant skills. For example, for a “sustainable energy” industry, criteria may include skills related to renewable energy production, energy-efficient technologies, and environmental sustainability.

Using the disclosed models and methods, the relevance of each skill to the industry of interest is assessed. Skills with higher probabilities of belonging to the industry are considered more relevant by the system and method. This step helps filter and prioritize skills that align with the focus of the educational journey.

Once the relevant skills are identified, educational path construction begins. Skill optimization techniques are applied to construct educational paths that maximize potential skill-mastery required in the selected industries while considering the unique aspect of each individual student/user previously uploaded by an administrator/hiring manager, user or an employee, contractor, or agent of the user or administrator/hiring manager. This involves selecting an appropriate path from the model outputs and weighing them based on their relevance to the industries and their likelihood of resulting in desired skill/industry mastery.

In certain embodiments, the paths are periodically or continuously monitored and rebalanced to ensure that they remain aligned with the intended skill/industry mastery desired over time. Regular monitoring allows for adjustments based on changes in technology, market conditions, and hiring trends.

Finally, the performance of the educational journeys are evaluated using key metrics such as retention, advancement, performance, student satisfaction, and employee satisfaction. Performance is compared to benchmark values previously uploaded by an administrator/hiring manager, user or an employee, contractor, or agent of the user or administrator/hiring manager to assess the effectiveness of the specific approach. Sensitivity analysis may also be conducted to understand the impact of different skills, industry certifications, and general hiring methods on employee performance.

Journey provides a more comprehensive skill competency representation than current approaches. In certain embodiments, Journey leverages advanced techniques in Bayesian Learning and Neural Networks that analyze multiple large text datasets to assign a skill to as many industries as are supported by the data. Journey manages model fit with a variety of rules-based safe-guards, ensuring high stability and interpretability. In certain embodiments, model training is done via a human-in-the-loop workflow to ensure that a practitioner's domain expertise is able to carefully guide the model towards an optimal solution that hedges against noisy and incomplete data. As outlined herein, Journey enables users, administrators, or hiring managers to better account for skill development or confirmation ignored by the current system, allowing them to provide a superior service to students and other adjacent individuals. Indeed, through this systematic process, users, administrators, and hiring managers can construct personalized educational paths, using the disclosed systems and methods, having known and auditable heterogeneous skill development at all times, thereby leveraging industry classifications to capture underlying nuanced skill-themes and skill-trends driving opportunities in the industry.

The present disclosure provides an artificial intelligence system, method, and computer-readable medium for constructing, constraining, and dynamically maintaining personalized educational pathways for students and other users. The system comprises a software application operating on a mobile or computer device, which communicates with an administrator, hiring manager, user, or their agent. The application is configured to receive user credentials and a target industry or occupation mastery, and to transmit this information to a server. A processor, in communication with the application and server, retrieves from a database a set of protocols and strategies—including document search strategies, text pre-processing protocols, topic modeling protocols, post-processing protocols, and neural network embeddings-based approaches—each of which may be previously uploaded by an authorized user or administrator. The processor identifies and links relevant documents to user skills, highlights keyphrases, determines industry-mastery thresholds, and calculates a cumulative industry-mastery designation. If the user's mastery does not meet the target within a defined tolerance, the processor constructs or adjusts the educational path to align with the desired mastery.

In certain embodiments, the system further includes features such as document search strategies that may be location-based, document-based, author-based, or combinations thereof; text pre-processing protocols that may include normalization, stemming, n-gram construction, stop-word removal, lemmatization, or combinations thereof; and topic modeling protocols that may utilize Bayesian learning frameworks or Latent Dirichlet Allocation (LDA). The neural network embeddings-based approach may assign scores or weights to each skill based on relevance, and the processor may apply trust-weighting to documents, construct a skills ontology mapping courses to in-demand skills and job outcomes, and perform skill gap analysis by comparing the skills ontology with real-time job market data.

The disclosure also provides a method for dynamically generating and maintaining a personalized educational pathway, comprising steps of receiving user credentials and target mastery, retrieving protocols and strategies from a database, identifying and linking relevant documents, highlighting keyphrases, determining mastery thresholds, and constructing or adjusting the educational path as needed. The method may further include performing skill gap analysis, providing personalized course recommendations, monitoring and rebalancing educational paths, evaluating performance using various metrics, employing human-in-the-loop workflows, and applying guardrails to restrict course enrollment based on user profile or performance.

Additionally, the disclosure encompasses a non-transitory computer-readable medium storing instructions that, when executed, cause a processor to perform the above steps. The instructions may further cause the processor to generate skill mastery scores for each course, provide a visual skill map of user progress, allow users to opt out of sharing personal data, integrate with existing student information and learning management systems, and update the skills ontology and educational pathways in response to emerging industries or skills identified by market trends or user preferences.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. The patent or application file contains at least one drawing executed in color. Copies of this patent or patent application publication with color drawing(s) will be provided by the Office upon request and payment of the necessary fee.

FIG. 1 shows an embodiment of the architecture of the disclosed system.

FIG. 2 shows an embodiment of the vector similarity and LLM search pattern model of the disclosed system.

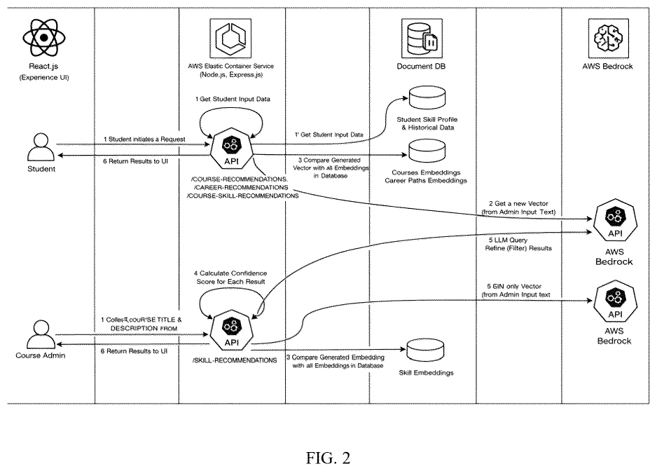

FIG. 3 shows an exemplary embodiment of a course recommendation model.

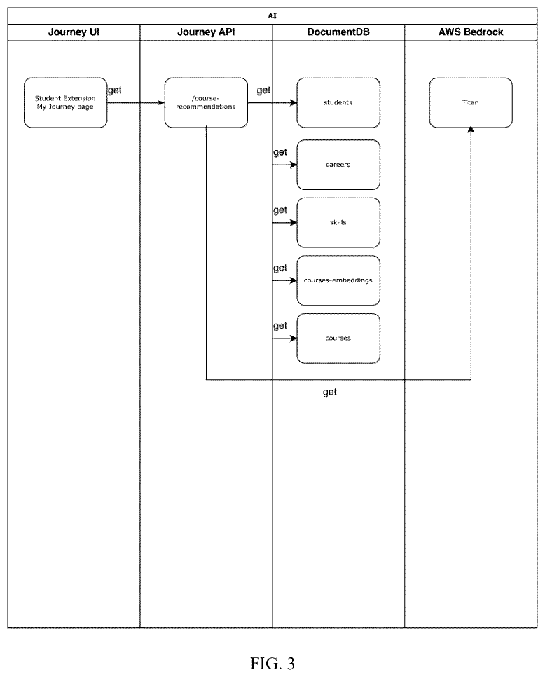

FIG. 4 shows an exemplary embodiment of the skills analysis workflow.

### DETAILED DESCRIPTION OF THE INVENTION

Various embodiments of the invention are described in detail below. Although specific implementations are described, this disclosure is provided for illustration purposes only. A person skilled in the relevant art will recognize that other components and configurations may be used without parting from the spirit and scope of this disclosure.

As disclosed herein, Journey, as the name implies, introduces an alternative approach in which multiple path(s) towards skill mastery may be constructed. In this manner, multiple paths whereby an individual may attain mastery of different skill(s)/industries are mapped. Recognizing that all individuals are unique, in certain embodiments Journey also evaluates the fitness of the individual to traverse the different paths and recommends the most appropriate path for that individual to attain mastery of specific skill(s)/industries that the individual identifies.

### Definitions

The term “industry” or “industries” means a category of products or services that require specific skills. This includes physical industries such as manufacturing and commodity extraction, as well as service industries such as IT and accounting. In most settings, the term “industry” or “industries” and “theme” or “themes” can be used interchangeably.

The term “black-box” refers to modeling frameworks, such as large language modeling (LLMs) such as GPT. A model is a “black-box” if the individual model parameters are generally not human-explainable and if failure-states of the model cannot be easily attributed to a specific aspect of the model that can be readily modified. While black-box models are highly popular, this inability to diagnose the nature of a model's mistakes is non-tolerable in the context of identifying the knowledge base an individual needs to master certain skills or industries in an ever-evolving world.

The term “neural network” means a computational model composed of interconnected nodes adapted to process data and recognize patterns. In a broad sense, a neural network may include any system or architecture that utilizes multiple layers of nodes or processing units to perform computations, make predictions, or extract features from input data. Such networks may be implemented in various forms, including but not limited to feedforward networks, convolutional networks, and recurrent networks. Neural networks may be trained using supervised, unsupervised, or reinforcement learning techniques, often employing optimization algorithms such as backpropagation and gradient descent to adjust connection weights and improve performance.

### Introduction

The invention provides a solution for the present need in the art for systems, methods, and devices for dynamic educational path construction and maintenance with desired skill levels and workforce outcomes. In certain embodiments, the disclosed system and method may be used to construct proposed educational path that gather a collection of courses offered in certain areas an administrator/hiring manager or user predicts will generate desired skill mastery over the long term based on monitoring of written information and disclosures of different employment outcomes over a set timeframe. The monitoring may be continuous or at set intervals. The invention solves the prior art problems using a computer-based platform that is specially programmed to construct and maintain a dynamic educational path that monitors changes in technology or desired skills and proactively adjusts the educational path to maximize the student's likely skill/industry mastery over a designated period of time.

The system synchronizes information from a server located at or connected to an administrator at an educational location or a hiring manager with the ever-changing market to chart an educational pathway intended to maximize the likelihood that the student gains mastery in the skills that are most desirable within an occupation or industry previously specified by the administrator/hiring manager, user or an employee, contractor, or agent of the user or administrator/hiring manager.

A detailed discussion of the methods and systems of the invention is provided below. First, a system overview is outlined. Second, the way a user may interact with the system and the employment of guardrails is identified. Third, discussion of the system components occurs. Fourth, a description of a cloud computing system, the preferred environment of this system, follows. Fifth, elements to further increase the performance of the systems and methods, which may be incorporated, are provided.

### System Overview

A system for constructing and dynamically maintaining a personalized educational journey is disclosed. The system includes a software application that obtains information about skills required for different industries and occupations, skills taught in educational courses, skills obtained by a user from previous courses taken and professional experience and certifications, and a processor which creates personalized educational journeys based on the information obtained. In certain embodiments, the system constructs and dynamically maintains the most ideal educational path from a given finite set of choices to cater to personal desires of the user or hiring manager.

At a high-level, the disclosed invention extracts high-importance keywords from a large collection of text to identify the most relevant skills corresponding to an industry or occupation. As with any data-oriented endeavor, the reliability of this skill/industry/occupation classification method is highly dependent on the quality of data sourcing and the robustness of the text pre-processing methodology that creates a model input dataset. The approach described below leads to better curated model input data, which invariably leads to a more useful model that produces journeys that lead to the most desirable outcome (e.g., skill-mastery, industry-credentials, gainful employment, etc.)

### Data Sourcing

The system and methods described herein begin by deploying search strategies for written documents related to specific skills desired in specific industries/occupations with the goal of obtaining as much diverse descriptive text data as possible about the skills associated with an industry/occupation, ideally from low-correlated sources. Such deployment may occur automatically. Regardless, the search strategies have been previously uploaded to the database by an administrator/hiring manager, user or an employee, contractor, or agent of the user or administrator/hiring manager. Such strategies may be operated continuously or at set intervals. Such search strategies may be location-based (e.g., search a company website for new documents), document-based (e.g., search for transcripts of students that were hired by a specific company), author-based (e.g., course reviews of faculty, notes, social media posts from a specific individual), or combinations thereof. The documents identified pursuant to these search strategies form the preliminary dataset.

In certain embodiments, data sourcing rules, previously uploaded to the database by previously uploaded by an administrator/hiring manager, user or an employee, contractor, or agent of the user or administrator/hiring manager, may be applied. For example, these rules may be: (1) a minimum document word count, (2) a minimum number of documents, (3) a minimum number of disparate locations of the documents, or (4) a combination thereof. Similarly, data sourcing rules related to the types of documents may also be employed. Examples of appropriate types of documents the system and method may utilize are: (1) 10-K business descriptions, (2) academic-written business descriptions, (3) patent filings, (4) news or social media feeds, and (7) other similar educational documents/notes. The reason for such a rule in certain embodiments is the system and method seek out document(s) that provide sufficient evidence for classification.

In certain embodiments, trust-weighting(s), previously uploaded to the database by previously uploaded by an administrator/hiring manager, user or an employee, contractor, or agent of the user or administrator/hiring manager, may be applied to the document. These trust-weighting(s) may be linked to each search strategy or document type. For example, a document located in the Electronic Data Gathering, Analysis and Retrieval (EDGAR) of the Securities and Exchange Commission (SEC) may be assigned a higher trust weighting than a social media post discussing industry needs. Such trust-weighting(s) allow for the consideration of a greater number of document(s) from more diverse source(s) without compromising the integrity of the system and method. For example, the system and method could supplement a dataset with news headlines and social media feeds even though such data sources provide less structure and require additional considerations for stable integration.

Simply put, the use of the data sourcing rule(s) and trust-weighting(s) allow the system and method to aggregate many separate documents into a single source that is ready for further processing.

### Data Pre-Processing

The system and methods described herein applies text pre-processing to the preliminary dataset to create a model-input dataset. In certain embodiments, this pre-processing identifies keywords previously uploaded to the database by an administrator/hiring manager, user or an employee, contractor, or agent of the user or administrator/hiring manager. The administrator/hiring manager, user or an employee, contractor, or agent of the user or administrator/hiring manager may in certain embodiments be a subject matter expert.

Such pre-processing may take the form of identifying/counting the number of keywords using a permutation-invariant multiset of words (e.g., a bag-of-words representation) to create a model-input dataset. Conversely, the pre-processing may utilize within-document context to extract meaning from text to summarize long documents into shorter versions that filter out irrelevant text (e.g., using a neural-net based natural language processor such as GPT) to create a model input dataset. Regardless, the purpose of pre-processing the preliminary dataset is to homogenize the model input data, which reduces the complexity of the input vocabulary and thus reduces the dimensionality of the model. The end result of this pre-processing is a model input data set comprising a collection of words such that each word is logically associated with only one skill.

Such pre-processing may include: (1) normalization, such as removing punctuation and converting all letters to lower-case, (2) stemming, where words are standardized to their root form such as making all words singular, (3) n-gram construction where words that satisfy a certain adjacency threshold previously uploaded to the database by previously uploaded by an administrator/hiring manager, user or an employee, contractor, or agent of the user or administrator/hiring manager are combined to form compound words such as “machine” within two words of “learning” may become “machine learning”, (4) stop-word removal, such as elimination of non-descriptive words, (5) lemmatization which maps a set of words to a single keyword that represents an aggregate meaning such as designating “apple” and “banana” both become “fruit”, and (6) combinations thereof.

In certain embodiments, Journey may leverage these tools to construct semantic trees that map a group of non-identical phrases to a single semantically unambiguous keyphrase that summarizes the essence of that group, while clearly corresponding to a single company or industry. In certain embodiments where lemmatization is used the set of words mapped to a single keyword may be synonyms, subcases of a general term, or combinations thereof. For example, clean-energy, green-energy, and green-power may all be mapped to renewable energy.

In certain embodiments, a semantic tree that summarizes how all the various tools operate together to homogenize the vocabulary is used. As semantics is inherently subjective, the construction of such trees requires careful discretion and domain expertise. For example, an administrator/hiring manager, user or an employee, contractor, or agent of the user or administrator/hiring manager may construct over 300 semantic trees that map over 9000 n-grams to semantically unambiguous keyphrases.

A full semantic tree may be vast with hundreds of nodes that account for subtle nuances in language, though regardless of scale, however, the logic doesn't need to be more complicated than what is described above. Regardless of size, in certain embodiments, the semantic tree utilized by the system or method will have previously uploaded to the database by an administrator/hiring manager, user or an employee, contractor, or agent of the user or administrator/hiring manager. By using such a human in the loop approach the system and method will not blindly adhere to a black-box modelling approach, but rather will leverage human expertise to guide the model towards a solution that best meets the user's specific needs.

In certain embodiments, Journey uses neural networks to process these data into text embeddings for use in text and document comparison, similarity searches, and recommendation engines.

In certain embodiments the magnitude the increase/decrease of the prevalence of key words and key phrases that appear in documents linked to specific skills/industries is calculated and tracked over a time horizon previously uploaded by the administrator/hiring manager, user or an employee, contractor, or agent of the user or administrator/hiring manager. Such calculation/tracking may be used by the systems or methods to predict the direction of different skills/industries and rebalance educational paths based on rules previously uploaded by the administrator/hiring manager, user or an employee, contractor, or agent of the user or administrator/hiring manager. For example, if Amazon® announces an intention to invest significantly in the quantum computing industry the systems and methods may appropriately adjust the skills required to succeed as an employee at Amazon® based on the upcoming capital deployment date (e.g., the need for employees with quantum computing expertise will likely move upward in a linear or non-linear fashion as the capital deployment date approaches).

In certain embodiments, semantics may be color coded or highlighted different colors. The highlighted/colored text may allow raw n-grams to be replaced with their associated semantically-unambiguous keyphrases (which may each correspond to a single color). The remaining text may be discarded. As a result, the result of data pre-processing is a preliminary data object in a bag-of-words form {ecommerce, ecommerce, engineering, cloud, cloud, . . . } which will be the input format necessary to construct a Skill Map.

### Skill/Industry Identification Via Topic Modeling

A topic model identifies clusters of frequently co-occurring words within a corpus. For sufficiently clean data, these clusters are often human-interpretable and share a common topic (hence the name). As a result of pre-processing, the preliminary data object is in a bag-of-words form containing semantically-unambiguous phrases relating to products and services. Journey defines each word-cluster as industry skills (e.g. a cluster including “computer-vision”, “machine-learning”, and “natural-language-processing” implies artificial intelligence). Once a topic model is trained, Journey can represent each input document as a probability distribution over topics, which in this case each correspond to a skill/industry. Thus, each description may be represented as a skill/industry mixture, allowing efficient/systematic identification of skills relevance for skill/industry mastery.

In certain embodiments, the modeling framework of the system and method utilizes a Bayes learning theory, which incorporates information contained in dataset X and prior parameter θ to estimate a posterior distribution as Formula 1 below:

$${\underbrace{P ( θ \vert X )}}_{posterior} ∝ {\underbrace{P ( X \vert θ )}}_{likelihood} {\underbrace{P ( θ )}}_{prior} \qquad Formula 1$$

Bayesian learning theory is a powerful framework used in statistics and machine learning for modeling uncertainty and making predictions based on data. In Bayesian learning, probability is interpreted as a measure of belief or uncertainty. Instead of treating probabilities as frequencies of events in the long run (as in frequentist statistics), Bayesians view probabilities as expressing subjective degrees of belief. At its core, Bayesian learning revolves around updating beliefs about the world as evidence accumulates.

Bayesian learning employs Bayes' theorem, which describes how to update prior beliefs in light of new evidence. Mathematically, it is represented as Formula 2 below:

$$P ( A \vert B ) = \frac{P ( B \vert A ) P ( A )}{P ( B )} \qquad Formula 2$$

Where, P(A|B) is the probability of event A given B (the posterior probability), P(B|A) is the probability of event B given A (the likelihood), P(A) and P(B) are the probabilities of events A and B respectively (the prior and marginal probabilities).

Bayesian learning starts with a prior probability distribution representing existing beliefs about the parameters or hypotheses of a model before observing any data. This prior can be based on previous experience, expert knowledge, or assumptions. The likelihood function captures how the observed data depend on the parameters of the model. It represents the probability of observing the data given different values of the parameters. After observing data, Bayes' theorem is used to update the prior beliefs, yielding the posterior distribution. The posterior distribution combines the prior beliefs with the observed data, providing a refined estimate of the parameters or hypotheses.

In Bayesian learning, parameter estimation involves computing the posterior distribution over the parameters given the observed data. This posterior distribution encapsulates uncertainty about the parameters and allows for probabilistic inference. Bayesian learning also facilitates model selection by comparing different hypotheses or models using their posterior probabilities. This allows for principled decisions about which model best explains the observed data, while accounting for model complexity and uncertainty. Bayesian learning naturally accommodates sequential updating of beliefs as new data becomes available. This iterative process allows for continual refinement of one or multiple models over time, making it suitable for online learning and adaptive systems.

As a person of ordinary skill in the art would understand, multiple topic model architectures are available. For example, the system and method disclosed herein may use of Latent Dirichlet Allocation (LDA).

### Model Fitting

Within a large corpus of text (multiple sources across multiple years) Journey is adapted to identify stable clusters of keywords as “skills” and “industries”, which reflect the choices made during data pre-processing. A feature of Journey is that due to the transparency and simplicity of the underlying mathematical process, the administrator/hiring manager, user or an employee, contractor, or agent of the user or administrator/hiring manager can bring forward certain industries/skills to appear in a system or method with 100% certainty by adding sufficient keywords to the pre-processor. Similarly, the administrator/hiring manager, user or an employee, contractor, or agent of the user or administrator/hiring manager can merge redundant industries/skills and eliminate irrelevant industries/skills by a similar mechanism. This type of model control is not possible within a black-box LLM such as GPT, highlighting the benefits of utilizing the disclosed model architectures. Indeed, the model architectures may employ: (1) human-in-the-loop learning, (2) non-parametric modeling, (3) model ensembling, (4) temporal updating, or (5) combinations thereof.

Human-in-the-Loop Learning is a process via which a model is iteratively improved in practice involves continuous human feedback. Specifically, human-in-the-loop is a workflow in which a model is fit, then a human audits the output to identify mistakes, readjusts the data pre-processor to address these mistakes, and finally re-fits the model. In practice, this process involves re-fitting the model a number of times where small improvements at each iteration lead to massive cumulative gains over time. Further, as the model iteratively improves, a momentum effect emerges in which convergence is sped up, and the audit process becomes more efficient.

Non-parametric modeling assists with the difficult decision that a practitioner must address which is the number of industries that appear in the final model. In certain embodiments, rather than set this number manually, Journey utilizes non-parametric Bayesian Learning to automatically “discover” the optimal number of skills/industries during the model fitting process. This ensures that an industry/skills appears if and only if sufficient evidence of its existence is supported by the data. This improves the identified skills/industries by confirming they are highly reliable and that the model has minimal sensitivity to noise.

Model ensembling promotes maximal model consistency and stability. In certain embodiments, rather than use a single model, Journey utilizes an ensembling approach in which it fits a large set of these non-parametric models in parallel, and only utilize industries/skills for which Journey identifies sufficient evidence of correlation across the ensemble. This high threshold for evidence significantly mitigates model risk.

Finally, temporal updating highlights a significant benefit of the Bayesian approach. Specifically, that the model can dynamically evolve as the skills/industries evolve over time, rather than needing to refit a new model from scratch at set intervals. Journey can utilize an existing model, and “update” parameters with new dataset, ensuring both interpretability and consistency on a time-series basis. This mechanism can even be set up in a manner such that the number of industries changes from year to year, allowing new skills/industries to naturally emerge and outdated skills/industries to expire. While black-box LLMs such as GPT also have mechanisms to update over time, they do not have temporal transparency, and it is often not clear which information was digested at which time-step, which is a significant problem for educational pathing in an ever-evolving world.

### Embeddings

In certain embodiments Journey employs “embeddings” to assess whether skills are represented in a text and then to assign a score or weight to that skill on the basis of the degree to which the embedding indicates that the skill is relevant to that text. In general NLP parlance, an “embedding” is a numeric representation of text within a high-dimensional mathematical space. Embeddings are generated using deep neural networks and pretrained Large Language Models. In certain embodiments, the input text may be converted into an embedding vector for which each dimension corresponds to one of the underlying industries/skills “discovered” by the model. The value of a vector at a specific dimension corresponds to the industry relevance of a particular skill. For example, if Tesla has a value of 1.0 along the dimension associated with the “automobile” industry, then Journey interprets this as saying that Telsa is an automobile firm with 100% certainty as opposed to a technology firm—which highlights the interpretability of Journey. As a contrast, for an LLM such as GPT, a similar interpretation of the embedding vector is not possible—as each dimension of the embedding space is an abstract combination of inputs that is inherently a black box. When estimating embeddings, one must carefully mange both false-positive and false-negative risk using a set of adjustments such as: (1) high evidence filters, (2) multi source validation, (3) multi-source blending, (4) appended implied industries, (5) adjusted correlated industries, or (6) combinations thereof.

In certain embodiments, high-evidence filters are used. High-evidence filter is used to knock out certain skills/industries below a certain threshold previously uploaded by administrator/hiring manager, user or an employee, contractor, or agent of the user or administrator/hiring manager. For example, in certain embodiments any industry/skill with a relevance score of less than 5% may be ignored, creating a sparse embedding in which each industry only has a small subset of retained skills. This reduces false-positive risk.

In certain embodiments, multi-source validation is used. In such embodiments, firms may have multiple independent sources of text for Journey to digest. Multi-source validation is used to knock out certain industries below a certain threshold previously uploaded by the administrator/hiring manager, user or an employee, contractor, or agent of the user or administrator/hiring manager. For example, in certain embodiments a skill that has high relevance (e.g., greater than 5%) across multiple sources is retained, if multiple sources are available. Again, this reduces false-positive risk.

In certain embodiments, multi-source blending is used. In such embodiments, once all low-evidence industries have been eliminated, Journey blends the embeddings of the individual sources together to construct a single composite representation of the firm. In some embodiments where not all documents are equally reliable, Journey uses “credibility-weighting”, previously uploaded by the administrator/hiring manager, user or an employee, contractor, or agent of the user or administrator/hiring manager, to ensure that more reliable documents have greater influence than those we believe to contain more noise.

In certain embodiments, appended implied industries/skills are used. In such embodiments, some industries/skills are sub-industries/sub-skills of more broadly defined super-industries/super-skills (for example “computer vision” is a subset of “artificial intelligence”), so Journey appends super-industries that are not explicitly mentioned in cases where only the sub-industry is discussed in the text. This reduces false-negative risk. As with the data pre-processing step, all sub/super industry/skill relations are determined by-hand at the discretion of a domain expert (i.e., they have been previously uploaded by an administrator/hiring manager, user or an employee, contractor, or agent of the user or administrator/hiring manager).

In certain embodiments, adjusted correlated industries/skills are used. In such embodiments, some industries/skills are intrinsically tied together, and thus Journey can boost the relevance of some pairs of co-occurring industries/skills. Like implied industry relations, correlated industry-skill relations are also determined by a domain expert.

### Mixture Models

Because of the nuance of the English language that make up the model input data, mixture models may be used. Mixture models are probabilistic models used to represent the idea that each data point can belong to multiple groups or categories simultaneously, with varying degrees of membership. In certain embodiments, mixture models can be thought of as probabilistic generalizations of the classical machine learning tool K-Means Clustering.

The described systems and methods employ at least two levels of mixture-models. For example, the mixture model may posit the following architecture: (1) to attain industry mastery, a mixture of skill mastery is required, and (2) each skill required to be mastered is a word-mixture.

Remember, a mixed-membership model is used for data in which each observation is a collection of elements (e.g., using BOW) such that each element belongs to a group. Mixed-membership models have prolific applications to various fields including document classification, social network analysis, and genetics. When mixed-membership models are applied to text, they are commonly referred to as “topic models”, the simplest of which is Latent Dirichlet Allocation (LDA).

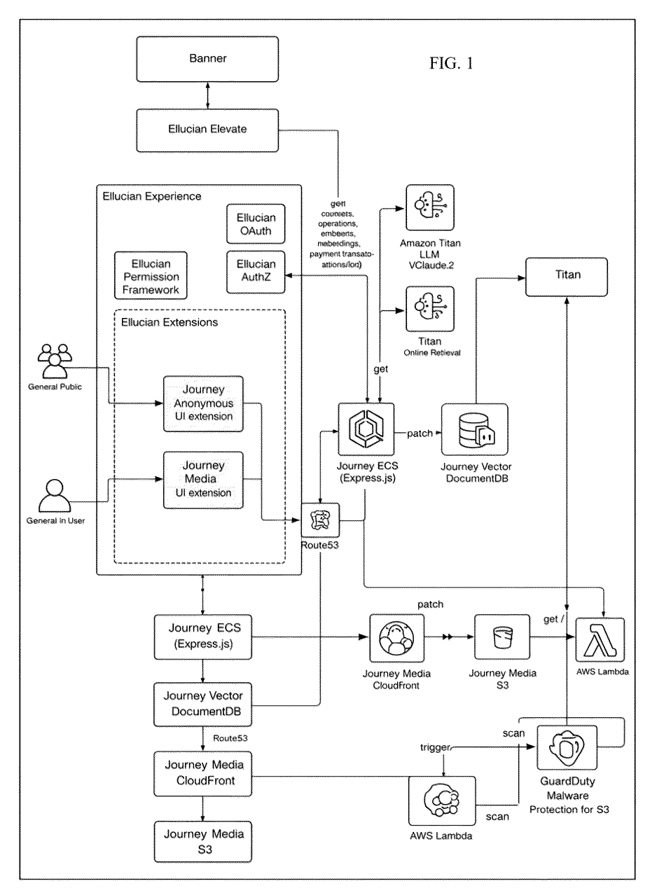

FIG. 1 depicts one embodiment of the described systems and methods. First, a “Skill Map”—a skills ontology created to enhance the educational experience—is a generated. It allows students to assess their current skills and competencies, discover new learning pathways, assess their career readiness, and explore occupations and industries relevant to their skills. Simultaneously, it enables staff to oversee the institution's educational programs at a more granular level, assessing the skills that are taught across courses and educational programs and their relevance to workforce outcomes rather than merely examining programs at the course level. This approach provides a quantifiable perspective on skills, offering deeper insights and more effective management of learning outcomes.

The Skill Map is generated by: (1) inputting the institution's course catalog data and elements of syllabus data as described above; (2) mapping this data to existing skills within a skills ontology previously uploaded to the database by an administrator/hiring manager, user or an employee, contractor, or agent of the user or administrator/hiring manager; and (3) leveraging AI in the manner described above to extract and suggest new skills.

Once established for the institution, the Skill Map is applied to student profiles. If the student has taken previous courses at the institution, their course progression would highlight the skill mastery they have achieved. For new students, it would initially be empty.

The Skill Map has three levels of definition: (1) industries—a larger category or bundling of skills that represent a mastery of a broad range of designated skills relevant to that industry; (2) skills—representing the core level of knowledge for tracking skill progression visually in the skill map; and (3) subskills—the most fine grained level of knowledge representing specific areas of expertise within a skill area. The following is an example of the structure: Information Technology (industry), Scripting Languages (skill), Python Programming (subskill). As outlined above, each skill is mapped to courses that help attain mastery in the skill. These elements come together to formulate career paths a student can set as their main goal. In certain embodiments, Journey provides a coverage score, which may include letters, numbers, or symbols. The coverage score represents how well a given course covers, or teaches, a certain skill. For example, using a scale of 1-10, a computer science course entitled Advanced Scripting Languages may receive a coverage score of 10 for the Scripting Languages skill while a computer science course entitled Introduction to Programming may receive a coverage score of 3 for the same skill.

In certain embodiments, the skill level may be calculated using Formula 3 below:

$${Priority}_{Skill} = {w}_{0} \cdot Coverage Score + {w}_{1} \cdot log ( Relevant Occupations ) \cdot \frac{1}{Specificity} + {w}_{2} \cdot Projected Growth + {w}_{3} \cdot log ( Current Demand ) + {w}_{4} \cdot Specificity + {w}_{5} \cdot Institutional Focus + {w}_{6} \cdot Regional Location Quotient + {w}_{7} \cdot State Location Quotient \qquad Formula 3$$

In such embodiments weights may be assigned as outlined in Table 1 below, when location data is taken into account:

This table represents the weights used when location data is taken into account:

| Weight | w₀ | w₁ | w₂ | w₃ | w₄ | w₅ | w₆ | w7 |
|---|---|---|---|---|---|---|---|---|
| Value | 0.22 | 0.05 | 0.08 | 0.17 | 0.15 | 0.05 | 0.2 | 0.08 |
| Metric | Coverage | Relevant | Projected | Current | Specificity | Institutional | Regional | State |
| | | Occupations | Growth | Demand | | Focus | Location | Location |
| | | | | | | | Quotient | Quotient |

| | |
|---|---|
| Sum | 1.0 |

In such embodiments, “Coverage” is the sum of the coverage scores for each time a skill was extracted from the curriculum. A lower coverage means that the skill is less well represented, which might make it a higher priority for addition. This metric is inverse normalized in the calculation, so a lower coverage value results in a higher priority score.

“Relevant Occupations” is the number of occupations that the skill is relevant to. Relevant meaning the skill is either defining or necessary for an occupation. A higher number means that the skill is more widely applicable to occupations, which might make it a higher priority for addition. We take the logarithm of this value to prevent the normalized values from being skewed from subcategory skills that very small or very large number of job postings in the last year. Then, we weight this value by the inverse specificity, saying that if the skill is more relevant to occupations we want to weigh by how broad the skill is. We want to deprioritize a skill here if it is broad and in a lot of occupations but prioritize if a skill is more specific and in many occupations.

“Projected Growth” is the projected growth of the skill. A higher growth rate means that the skill is expected to become more important in the future, which might make it a higher priority to universities. The projected growth may be evaluated over any timeframe (e.g., 2 years) pulled from proprietary or public databases. In such embodiments, “Projected Growth” could also use the total number of job postings mentioning a skill divided by total job postings in the last year as well. A higher demand means that the skill is more sought after by employers, which might make it a higher priority for addition.

“Current Demand” is the current demand for the skill. In certain embodiments, the system or method uses the number of job postings mentioning a skill in the past year but could use the total number of job postings mentioning a skill divided by total job postings in the last year as well. A higher demand means that the skill is more sought after by employers, which might make it a higher priority for addition.

“Specificity” is the number of skills, pulled from proprietary or public database(s), that fall under this subcategory skill. A higher specificity means that the subcategory is broader, since many different skills fall under it, and a lower specificity means that there is less specialization under this skill, so it is less broad. In certain embodiments the system or method prioritizes more broad skills since they have more to cover under them which may indicate to individuals that an educational provider is not teaching at the best level it could.

“Institutional Focus” indicates whether a skill is part of important career path(s) for an institution. In certain embodiments, for each career, the sum of coverage for all skills necessary and defining for that career(S) and percentage of skills in career with >0 coverage (P), which may be defined as: Coverage_index_{occupation}=S*P. In certain embodiments, for a given skill, the system or method finds all occupations the skill is either necessary or defining for, and that have an occupation coverage index that is in the upper n-th percentile of all coverage indexes. Such embodiments may rank order those careers, take the above list and calculate an average coverage index for these occupations (average coverage index is 0 if no occupations mention this skill and coverage index of this occupation is not above threshold.) Now, this metric can be taken both ways in some sense: Prioritizing skills with high institutional focus values that reinforces existing strengths, while prioritizing skills with low institutional focus values that addresses gaps and broadens preparation. The decision on which to prioritize depends on the institution's strategic goals—whether to strengthen existing capabilities of well-defined career preparation paths, or to diversify and fill gaps in skill coverage.

In such embodiments identified above, an educational institution may be able to choose whether or not location data is taken into account. Indeed, location data is one element of the system or method that permits the institution administrator to be able to view the skill mapping and work with their faculty and department leads to adjust as needed. For example, administrators can import courses from the traditional course catalog (either credit courses or courses marked as “continuing education”) into Journey through a data import. They are also able to launch new courses and sections within Journey, forming the catalog and schedule that students can browse and enroll in.

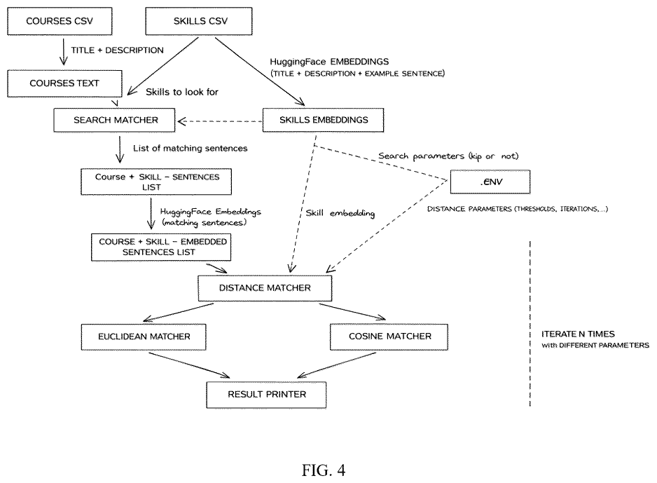

Students are able to browse the institution's Journey catalog and, in certain embodiments, schedule without a formal student ID as an unauthenticated user. If they choose to engage further, they are asked to use existing institution credentials or setup a new ID. By perusing the catalog and navigating the skill map, students are able to browse courses and career paths of interest. Once the student identifies a “career path” of interest, they may then set that as their desired career path in their profile, which outlines a progression of skills to meet current employer demands in that career path. The student can then see suggested courses to gain mastery in each skill, select courses they want to take, and then register and pay for those courses. Indeed, FIG. 4, outlines one embodiment of the manner by which a user may receiver recommendations and enroll in a career path.

### Improvements Over Prior Art

Journey's unique advantages are it: (1) is platform agnostic; (2) creates clear connection between data sources—currently institutions manage these integrations on their own, Journey integrates then wraps an entire learner and admin experience on top of the core data sources; and (3) creates connectivity between curriculum data, workforce data, and student profile data to create a novel student experience.

Journey may assess the level of skill mastery gained from a particular course through several key metrics, including: (1) course level: categorization as beginner, intermediate, or advanced; (2) time to complete: measured in units or duration required for course completion; (3) skill referencing: analysis of how the skill is mentioned across the course description and syllabus; (4) prominent skill placement: determining whether the skill appears in critical locations such as the course title.

The resulting skill mastery score may be used to: (1) build comprehensive student profiles; (2) track skill progression toward mastery of all skills relevant to a specific occupation or career path.

The system's AI recommendation engine pairs students with new learning opportunities and career pathways by: (1) analyzing student profiles, including completed courses and skill mastery; and (2) generating potential courses for institutions to consider based on student search patterns. These generated course suggestions may include: (1) subject, course, and department; (2) skill mappings and faculty attributes (e.g., full-time, part-time, adjunct); (3) recommended instructional methods (e.g., remote, in-person, hybrid); (4) credit versus non-credit options; and (5) defined learning outcomes and syllabus content.

In certain embodiments, the system performs skill gap analysis to classify capabilities and prioritize skills for institutional focus. Key metrics used in this analysis may include: (1) current skill coverage: assessing how well the institution teaches the skill; (2) related skill coverage: evaluating coverage of associated skills; (3) career path relevance: determining the institution's strengths in career paths related to the skill; (4) workforce demand: using external data from sources such as Lightcast® to assess local and national demand for the skill; (5) growth trajectory: analyzing past and predicted growth trajectories of the skill; and (6) career path importance: evaluating how many career paths require the skill and its significance within those paths (central or ancillary). This robust analysis enables institutions to: (1) identify gaps in their current offerings; (2) tailor programs to align with workforce trends and student aspirations; and (3) strengthen their position in preparing students for future employment opportunities.

System Interaction with Users

In certain embodiments, a constraint linked to each path may be uploaded to the database by an administrator/hiring manager, user or an employee, contractor, or agent of the user or administrator/hiring manager. Examples of such constraints are industries, competitors of designated firms, or target industry-mastery and skill mastery scores. In certain embodiments, the an administrator/hiring manager, user or an employee, contractor, or agent of the user or administrator/hiring manager may designate a minimum relationship between skill mastery that they wish for applicants/employees to maintain. In such embodiments, the processor may not only seek to maximize the journey's likelihood of obtaining the desired industry-mastery, but also seek to maximize the relatedness of the skills mastered to the desired industry.

In certain embodiments, the system includes guardrails. Such guardrails may prevent unprepared students, who may have unrealistic views of the skills they have mastered, from taking on too much work. In such an embodiment, skills are categorized into groups based on the omnibus student profile determined by the disclosed systems and methods. In addition, a guardrail factor for each classification may be uploaded by an administrator/hiring manager, user or an employee, contractor, or agent of the user or administrator/hiring manager. Such a guardrail factor may be numeric (e.g., from 0 and 100) and will restrict how many classes any journey may include at any one time. By restricting risk of overloading the student, the guardrail factor restricts the amount of classes the student may take.

In other embodiments, the guardrails may be in writing. By way of example, the hiring manager may upload a recent performance evaluation of an individual who may be classified as “Needs Improvement”, “Meets Expectations” or “Exceeds Expectations” depending on the review. These classifications may coincide with numeric values previously uploaded to the database by an administrator/hiring manager, user or an employee, contractor, or agent of the user or administrator/hiring manager. For example, the guardrails for “Needs Improvement” investors may be 50, for “Meets Expectations” investors may be 75 and there may be no guardrail factor entered for “Exceeds Expectations”. If there is no guardrail factor uploaded, the individual would have access to the entire range of courses available. With such guardrail factors in place, individuals that “Need Improvement” are restricted to 50% of the total course catalog. Similarly, “Meets Expectations” may permit individuals to access up to 75% of the course catalog.

### System Components

A non-limiting embodiment of the system includes a general-purpose computing device, having a processing unit (CPU or processor), and a system bus that couples various system components including the system memory such as read only memory (ROM) and random-access memory (RAM) to the processor. The system can include a storage device connected to the processor by the system bus. The system can include interfaces connected to the processor by the system bus. The system can include a cache of high-speed memory connected directly with, in close proximity to, or integrated as part of the processor. The system can copy data from the memory and/or a storage device to the cache for quick access by the processor. In this way, the cache provides a performance boost that avoids processor delays while waiting for data. These and other modules stored in the memory, storage device, or cache can control or be configured to control the processor to perform various actions. Other system memory may be available for use as well. The memory can include multiple different types of memory with different performance characteristics.

### Computer Processor

The invention may operate on a computing device with more than one processor or on a group or cluster of computing devices networked together to provide greater processing capability. The processor can include any general-purpose processor and a hardware module or software module, stored in an external or internal storage device, configured to control the processor as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity purposes, an illustrative system embodiment is presented as having individual functional blocks including functional blocks labeled as a “processor.” The functions such blocks represent may be provided through the use of either shared or dedicated hardware, including, but not limited to, hardware capable of executing software and hardware, such as a processor, which is purpose-built to operate as an equivalent to software executing on a general-purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, read-only memory (ROM) for storing software performing the operations discussed in this document, and random-access memory (RAM) for storing results. Very large-scale integration (VLSI) hardware embodiments, as well as custom VLSI circuitry in combination with a general-purpose DSP circuit, may also be provided.

### System Bus

The system bus may be any of several types of bus structures including a memory bus or memory controller, a peripheral bus, and a local bus using any of a variety of bus architectures. A basic input/output system (BIOS) stored in ROM or the like may provide the basic routine that helps to transfer information between elements within the computing device, such as during start-up.

### Storage Device

The computing device can further include a storage device such as a hard disk drive, a magnetic disk drive, an optical disk drive, a solid-state drive, a tape drive or the like. Similar to the system memory, a storage device may be used to store data files, such as location information, menus, software, wired and wireless connection information (e.g., information that may enable the mobile device to establish a wired or wireless connection, such as a USB, Bluetooth, or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld, computing device, a desktop computer, or a computer server.

Although an embodiment described in this document uses cloud computing and cloud storage, it should be appreciated by those skilled in the art that other types of computer-readable media which can store data that are accessible by a computer, such as magnetic cassettes, flash memory cards, digital versatile disks, cartridges, random access memories (RAMS), read only memories (ROMS), a cable or wireless signal containing a bit stream and the like, may also be used in the operating environment. Furthermore, non-transitory computer-readable storage media as used in this document include all computer-readable media, with the sole exception being a transitory propagating signal per se.

### Interface

To enable user interaction with the computing device, an input device represents any number of input mechanisms, such as a microphone for speech, a web camera for video, a touch-sensitive screen for gesture or graphical input, a keyboard, a mouse, a motion input, and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output and/or communication interface.

There is no restriction on operating on any particular hardware arrangement and therefore the basic features disclosed may easily be substituted for improved hardware or firmware arrangements as they are developed.

### Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor, then these modules may be loaded into RAM or memory at runtime or may be stored as would be known in the art in other computer-readable memory locations. Having disclosed some components of a computing system, the disclosure now turns to a description of cloud computing, which is the preferred environment of the invention.

### Cloud System

Cloud computing is a type of Internet-based computing in which a variety of resources are hosted and/or controlled by an entity and made available by the entity to authorized users via the Internet. A cloud computing system can be configured so that a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

### Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network-enabled computing devices. For example, cloud computing resources can communicate with a server, a database, and/or any other network-enabled computing device to provide the cloud resources.

In some cases, the cloud resources can be redundant. For example, if cloud computing resources are configured to provide data backup services, multiple copies of the data can be stored such that the data are still available to the user even if a storage resource is offline, busy, or otherwise unavailable to process a request. In another example, if a cloud computing resource is configured to provide software, then the software can be available from different cloud servers so that the software can be served from any of the different cloud servers. Algorithms can be applied such that the closest server or the server with the lowest current load is selected to process a given request.

### User Terminal

A user interacts with cloud computing resources through user terminals or testing devices connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. In other cases, however, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

### Service Models

Cloud computing resources can provide cloud resources to user terminals through a variety of service models, such as Software as a Service (Saas), Platforms as a Service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

### User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or databases.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of the cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

### Collection Of Data

In some configurations, during the creation or maintenance of the educational paths described above, a storage device or resource can be used to store relevant data. Examples of the data contemplated for storage are user personal data, location data, and employment data. The data stored can be incorporated into the disclosed system and methods used to refine the efficient frontier 400 to adjust for asymmetric goals such as tax issues and restrictions on the investor's holding options based on employment status. In addition, collected data may be used for single command responses to update inquiries propounded by the system in response to a personal or market-driven event (e.g., the investor loses their job, or the market drops 5%).

### User Personal Data

The invention contemplates that, in some instances, this gathered data might include user personal and/or sensitive data. The invention further contemplates that the entities responsible for the collection, analysis, disclosure, transfer, storage, or other use of such data should implement and consistently use privacy policies and practices that are generally recognized as meeting or exceeding industry or governmental requirements for maintaining personal information and keeping data private and secure. For example, personal data from users should be collected for legitimate and reasonable uses of the entity and not shared or sold outside of those legitimate uses. Further, such collection should occur only after the informed consent of the users. In addition, such entities should take any needed steps to safeguard and secure access to such personal data and ensure that others with access to the personal data adhere to their privacy and security policies and procedures. Further, such entities can subject themselves to evaluation by third parties to certify their adherence to widely accepted privacy policies and practices.

### User Opt-Out

Despite the foregoing, the invention also contemplates embodiments in which users selectively block the use of, or access to, personal data. That is, the invention contemplates that hardware and/or software elements can be provided to prevent or block access to such personal data. For example, the present technology can be configured to allow users to select the data that are stored in cloud storage. In another example, the present technology can also be configured to allow a user to specify the data stored in cloud storage that can be shared with any administrator/hiring manager, user or an employee, contractor, or agent of the user or administrator/hiring manager.

Therefore, although the invention broadly covers use of personal data to implement one or more various disclosed embodiments, the invention also contemplates that the various embodiments can also be implemented without the need for accessing such personal data. That is, the various embodiments of the present technology are not rendered inoperable due to the lack of all or a portion of such personal data.

While this subject matter has been disclosed with reference to specific embodiments, it is apparent that other embodiments and variations can be devised by others skilled in the art without departing from the true spirit and scope of the subject matter described herein.

What is claimed is:

1. An artificial intelligence system for constructing, constraining, and dynamically maintaining an educational pathway for a student, the system comprising:
a software application, the application operating on a mobile computer device or on a computer device, which is in communication with an administrator/hiring manager, user or an employee, contractor, or agent of the user or administrator/hiring manager, wherein the application is configured to receive the following subject information from the an administrator/hiring manager, user or an employee, contractor, or agent of the user or administrator/hiring manager: (a) a list identifying credentials of a user, and (b) a target industry/occupation-mastery for the student, wherein, the software application is further configured to communicate the subject information through a wired and/or wireless communication network to a server located at a site where an administrator/hiring manager, user or an employee, contractor, or agent of the user or administrator/hiring manager is physically present or at a location remote from the site; and
a processor that is in communication through the wired and/or wireless communication network with the software application, as well as the server, the processer is configured to recall from a database of the system, upon communication of the subject information to the server: (a) document search strategies, (b) a text pre-processing protocol, (c) a topic modeling protocol, (d) a post-processing protocol, wherein the document search strategies, test pre-processing protocol, topic modeling protocol, and post-processing protocol were previously uploaded to the database by the administrator/hiring manager, user or an employee, contractor, or agent of the user or administrator/hiring manager, and (e) a neural network embeddings-based approach to skill matching/tracking and course and occupation recommendations;
whereby the processor identifies and links relevant documents to individual skills of the user using the document search strategies
whereby the processor highlights keyphrases within the linked documents using the text pre-processing protocol;
whereby the processor determines an industry-mastery threshold for each of the skills of the student based on the topic modeling protocol as applied to the keyphrases;
whereby the processor determines a cumulative industry-mastery designation based on the skills of the user;
whereby when the cumulative industry mastery designation based on the skills of the user does not equal the target industry mastery within a range of tolerance, the processor constructs or adjusts the educational path of the user to align with the target industry mastery desired.

2. The system of claim 1, wherein the document search strategies include location-based, document-based, author-based, or combinations thereof, for identifying relevant documents.

3. The system of claim 1, wherein the text pre-processing protocol includes normalization, stemming, n-gram construction, stop-word removal, lemmatization, or combinations thereof.

4. The system of claim 1, wherein the topic modeling protocol comprises a Bayesian learning framework or Latent Dirichlet Allocation (LDA).

5. The system of claim 1, wherein the neural network embeddings-based approach assigns a score or weight to each skill based on the degree of relevance to the user's educational or occupational goals.

6. The system of claim 1, wherein the processor is further configured to apply trust-weighting to documents based on their source or type.

7. The system of claim 1, wherein the processor is further configured to construct a skills ontology mapping courses to specific, in-demand skills and corresponding job or occupational outcomes.

8. A method for dynamically generating and maintaining a personalized educational pathway for a user, comprising:
receiving, via a software application, user credentials and a target industry or occupation mastery;
retrieving, from a database, document search strategies, a text pre-processing protocol, a topic modeling protocol, a post-processing protocol, and a neural network embeddings-based approach, wherein each was previously uploaded by an administrator, hiring manager, user, or an employee, contractor, or agent thereof;
identifying and linking relevant documents to individual skills of the user using the document search strategies;
highlighting keyphrases within the linked documents using the text pre-processing protocol;
determining an industry-mastery threshold for each of the skills of the user based on the topic modeling protocol as applied to the keyphrases;
determining a cumulative industry-mastery designation based on the skills of the user; and,
when the cumulative industry mastery designation does not equal the target industry mastery within a range of tolerance, constructing or adjusting the educational path of the user to align with the target industry mastery desired.

9. The method of claim 8, further comprising performing skill gap analysis by comparing the skills ontology with real-time job market data.

10. The method of claim 8, further comprising providing personalized course recommendations to the user based on the user's profile and labor market trends.

11. The method of claim 8, further comprising periodically or continuously monitoring and rebalancing educational paths based on changes in technology, market conditions, or hiring trends.

12. The method of claim 8, further comprising evaluating the performance of educational journeys using metrics selected from the group consisting of retention, advancement, performance, student satisfaction, and employee satisfaction.

13. The method of claim 8, further comprising employing a human-in-the-loop workflow to iteratively improve model accuracy and interpretability.

14. The method of claim 8, further comprising applying guardrails to restrict the number or type of courses a user may enroll in based on user profile or performance evaluations.

15. A non-transitory computer-readable medium storing instructions that, when executed by a processor, cause the processor to:
receive user credentials and a target industry or occupation mastery;
recall from a database document search strategies, a text pre-processing protocol, a topic modeling protocol, a post-processing protocol, and a neural network embeddings-based approach, each previously uploaded by an administrator, hiring manager, user, or an employee, contractor, or agent thereof;
identify and link relevant documents to individual skills of the user using the document search strategies;
highlight keyphrases within the linked documents using the text pre-processing protocol;
determine an industry-mastery threshold for each of the skills of the user based on the topic modeling protocol as applied to the keyphrases;
determine a cumulative industry-mastery designation based on the skills of the user;
and, when the cumulative industry mastery designation does not equal the target industry mastery within a range of tolerance, construct or adjust the educational path of the user to align with the target industry mastery desired.

16. The non-transitory computer-readable medium of claim 15, wherein the instructions further cause the processor to generate a skill mastery score for each course based on course level, time to complete, skill referencing, and prominent skill placement.

17. The non-transitory computer-readable medium of claim 15, wherein the instructions further cause the processor to provide a visual skill map showing the user's progress toward mastery of skills relevant to a selected career path.

18. The non-transitory computer-readable medium of claim 15, wherein the instructions further cause the processor to allow users to opt out of sharing personal data or to select which data are stored or shared.

19. The non-transitory computer-readable medium of claim 15, wherein the instructions further cause the processor to integrate with existing student information systems (SIS) and learning management systems (LMS).

20. The non-transitory computer-readable medium of claim 15, wherein the instructions further cause the processor to update the skills ontology and educational pathways in response to emerging industries or skills identified by market trends or user preferences.
